(19) United States
(12) Patent Application Publication
(10) Pub. No.: US 2014/0324513 A1
(43) Pub. Date: Oct. 30, 2014

(54) COMPUTERIZED SYSTEMS AND COMPUTER-IMPLEMENTED METHODS RELATED TO BUSINESS PROCESSES AND IMPROVEMENTS THEREOF

(71) Applicant: FRONTSPHERE, INC., San Mateo, CA (US)

(72) Inventors: VLADIMIR KHALUTIN, St. Petersburg (RU); VALERY VAKHRUSHEV, St. Petersburg (RU); KONSTANTIN ZUBOV, Moscow (RU)

(73) Assignee: FRONTSPHERE, INC., San Mateo, CA (US)

(21) Appl. No.: 14/106,712

(22) Filed: Dec. 13, 2013

Related U.S. Application Data
(60) Provisional application No. 61/737,096, filed on Dec. 13, 2012.

(51) Int. Cl. G06Q 10/06; H04M 7/00; H04M 3/51

(52) U.S. Cl. CPC G06Q 10/06316; H04M 3/51; H04M 7/006
USPC 705/7.26

(57) ABSTRACT

System for automating a business process, the system comprising at least one processing unit, a data storage unit and a memory unit, the processing unit executing a set of computer-readable instructions implementing a method comprising: receiving data associated with the business process from an agent or by means of a data upload and storing the received data; determining whether a process instance corresponding to the input data has already been run, and, if not, initiating a business process instance; executing the business process instance according to a visual definition specified by the user; determining whether the business process requires a voice communication with a customer and, if so, initiating a voice communication connection between an agent and the customer; and determining whether the business process requires a message to be sent to the customer and, if so, automatically generating the message and sending the generated message to the customer.

### CROSS-REFERENCE TO RELATED PATENT APPLICATION

The present regular U.S. patent application relies upon and claims the benefit of priority from U.S. provisional patent application No. 61/737,096 filed on Dec. 13, 2012, the entire disclosure of which is incorporated by reference herein.

### BACKGROUND OF THE INVENTION

1. Field of the Invention

The described embodiments relate in general to business automation and, more particularly, to computerized methods and systems for automation of various business processes.

2. Description of the Related Art

Existing systems for building applications for supporting business processes (business process management (BPM) platforms) are complex and require substantial expenditure of specialized labor for process setup and system configuration. This makes the business application setup process very expensive and time-consuming. In addition, the existing business automation systems lack seamless integration with telephony systems and other available non-voice communication facilities.

Therefore, there is a long-recognized need for computerized methods and systems for deploying applications for automation of various business processes that would be simple to set up and configure and would provide seamless integration with telephony and other communication systems.

### SUMMARY OF THE INVENTION

The embodiments described herein are directed to methods and systems that substantially obviate one or more of the above and other problems associated with conventional systems and methods for automating business processes.

In accordance with one aspect of the embodiments described herein, there is provided a computerized system for automating a business process, the computerized system comprising at least one processing unit, a data storage unit and a memory unit, the at least one processing unit executing a set of computer-readable instructions implementing a method comprising: receiving data associated with the business process from an agent or by means of a data upload and storing the received data; determining whether a process instance corresponding to the input data has already been run, and, if not, initiating a business process instance; executing the business process instance according to a visual definition specified by the user; determining whether the business process requires a voice communication with a customer and, if so, initiating a voice communication connection between an agent and the customer; and determining whether the business process requires a message to be sent to the customer and, if so, automatically generating the message and sending the generated message to the customer.

In accordance with another aspect of the embodiments described herein, there is provided a computer-implemented method for automating a business process, the computer-implemented method being performed in connection with a computerized system comprising at least one processing unit, a data storage unit and a memory unit, the computer-implemented method comprising: receiving data associated with the business process from an agent or by means of a data upload and storing the received data; determining whether a process instance corresponding to the input data has already been run, and, if not, initiating a business process instance; executing the business process instance according to a visual definition specified by the user; determining whether the business process requires a voice communication with a customer and, if so, initiating a voice communication connection between an agent and the customer; and determining whether the business process requires a message to be sent to the customer and, if so, automatically generating the message and sending the generated message to the customer.

In accordance with yet another aspect of the embodiments described herein, there is provided a non-transitory computer-readable medium embodying a set of instructions, which, when executed in connection with a computerized system comprising at least one processing unit, a data storage unit and a memory unit, cause the computerized system to perform a computer-implemented method comprising: receiving data associated with the business process from an agent or by means of a data upload and storing the received data; determining whether a process instance corresponding to the input data has already been run, and, if not, initiating a business process instance; executing the business process instance according to a visual definition specified by the user; determining whether the business process requires a voice communication with a customer and, if so, initiating a voice communication connection between an agent and the customer; and determining whether the business process requires a message to be sent to the customer and, if so, automatically generating the message and sending the generated message to the customer.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a computerized system for automating business processes.

FIG. 2 illustrates an exemplary operating sequence of an embodiment of the computerized system for automating business processes.

FIG. 3 illustrates an exemplary embodiment of a computerized system and method for automatically configuring reporting function based on the description of the business process.

FIG. 4 illustrates an exemplary operating sequence of an embodiment of the computerized system for automatically configuring reporting function based on the description of the business process.

FIG. 5 illustrates an exemplary embodiment of the computerized system for Integration of voice or video interaction between the operator and the customer into the formalized business process.

FIG. 6 illustrates an exemplary operating sequence of an embodiment of the computerized system for integration of voice or video interaction between the operator and the customer into the formalized business process.

FIG. 7 illustrates an embodiment of a hardware platform for implementing the embodiments of the systems for automating business processes described herein.

### DETAILED DESCRIPTION

In the following detailed description, reference is made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

### Designing of Visual Business Process Diagram for Customer Interaction Using Client-Provided Contact Information

In accordance with one aspect of the embodiments described herein, there is provided a computerized system and method for designing of visual business process diagram for customer interaction based on the client-provided contact information.

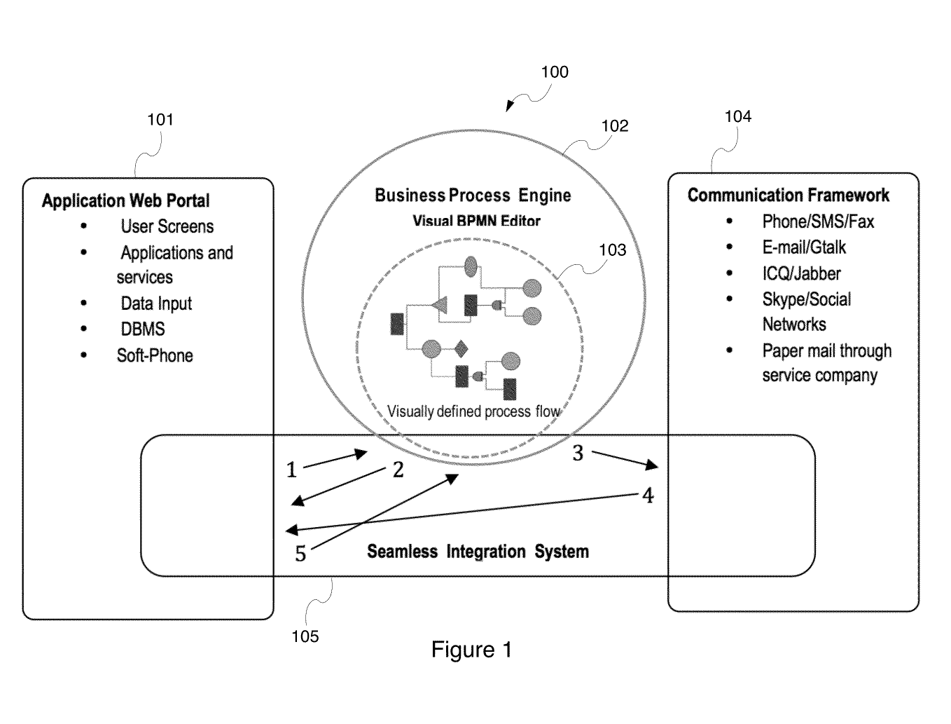

FIG. 1 illustrates an exemplary embodiment of the computerized system 100 for automating business processes. The system 100 incorporates an application web portal 101, which may be deployed based, for example, on the Liferay™ platform well known to persons of ordinary skill in the art. The application web portal 101 provides user interfaces for the users, which may be implemented use web-based user interfaces, various applications and services, data input facilities, database management system (DBMS) as well as telephony interfaces, such as soft-phone application known to persons of ordinary skill in the art. In one or more embodiments, the database management system may be implemented based on any now known or later developed type of database software, such as a relational database management system, including, without limitation, MySQL, Oracle, SQL Server, DB2, SQL Anywhere, PostgreSQL, SQLite, Firebird and/or MaxDB, which are well-known to persons of skill in the art. In an alternative embodiment, a cloud-based distributed database, such as Amazon Relational Database Service (Amazon RDS), well known to persons of ordinary skill in the art, may also be used to implement the database management system. In one or more embodiments, the portal applications may include, without limitation:

1. An application for the operator implementation of soft-phone, forms for recording the results of conversation, navigation and demonstrating all the necessary information during a call to the operator, the management of operator's availability and navigation of his tasks.

2. An application for manual and automatic loading of data from various sources and services.

3. An application to generate text messages in accordance with the data on the client.

4. An application that displays reporting about communications and business processes.

5. A customer relationship management (CRM) application, well known to persons of ordinary skill in the art.

In one or more embodiments, the computerized system 100 further includes a business process engine 102, which may be an Activity™ or similar system, well known to persons of ordinary skill in the art. The business process engine 102 enables the user to create visually defined process flow 103. In one or more embodiments, the term business process used herein describes the process of customer service and communication strategy of interaction with the client being serviced. In one or more embodiments, the business process description includes, for example, information with respect to phases and stages of the client service process when the client should be called and/or receive non-voice messages, how various contact details of the business client should be used (simultaneously or sequentially), and the ways for handling the manually entered or downloaded data and communication failures. In one or more embodiments, the business process description can be created and modified by a business user in accordance with the real customer service model using the application web portal 101.

In one or more embodiments, the computerized system 100 further includes a communication framework 104, which may be an Asterisk™ or similar system, well known to persons of ordinary skill in the art. The communication framework 105 provides various means of communication with the business client, including phone/SMS/Fax, email, instant message, Skype, social networks or even the conventional paper mail.

In one or more embodiments, the computerized system 100 further includes an integration system 105, which me deployed as a specially designed software that allows to combine the above systems 101, 102 and 104. The computerized system 100 is configured to perform, for example, the following steps:

1. user and/or application actions in the web portal 101, such as loading or entering user data, initiating a business process or influencing its flow;

2. steps of the business process, which initiates user activities and/or application actions in the portal;

3. step of the business process that initiates communication using the business client-provided contact information;

4. connection of a portal application with communication session in the portal;

5. return of the results of communication in the business process.

In one or more embodiments, the computerized system 100 provides separation of functions of business customer service process between the aforesaid constituent systems 101, 102 and 104. Specifically, the application web portal 101 performs interfacing for an agent and data input/output. The communication system 104 provides synchronous and asynchronous interactions with the business customer. Finally, the business process engine 102 performs the execution of the logic of the business process, formalized in a simple visual form using a visual process editor 103.

In one or more embodiments, the business (customer service) process is formalized and defined by means of a business process model and notation (BPMN) diagram 103, using a corresponding visual diagram editor, well known to persons of ordinary skill in the art, deployed in the business process engine 102. A step of obtaining client's data, including contact information (addresses) for interaction by means of any voice, text and video online and offline channels (SMS/texting, phone, paper mail, jabber, Skype, social networks, etc.) is defined in the aforesaid process.

In the further description of the process the following steps are used: 1) the customer interaction steps and 2) steps of branching based on the data obtained in the course of the aforesaid customer interaction.

In one or more embodiments, the computerized system 100 executes a business process specified using the aforesaid visual diagram technique and enables the instance of the business process being executed to interact with the telecommunication channels provided by the communication framework 104. Specifically, the executed business process may query the communication framework 104 to obtain the availability status of the address(es) in the specific communication channel(s), place a call in connection with a communication channel, and obtain from the client certain data, usable by the business process logic at a future time.

In one or more embodiments, various data is obtained and delivered in the business process in the following manner:

1. The system connects an agent and a client, and the agent in the process of the call or video-call inserts the data reported by the customer into the fields of fixing the results described in the process.

2. The system sends a text message and expects a reply in accordance with a certain timer, absence of reply or failure of sending a message is also obtaining of data.

3. The system interacts with a client and obtains data with the help of voice menu.

4. The system draws up a text of an off-line letter for the service of sending paper letters.

5. Data from external systems is loaded into the system (extracts from payment systems, received messages in the standard from etc.).

6. Data is inserted in the system by an agent (data from voice messages, customers' incoming calls, paper letters, faxes etc.)

7. Any other suitable means.

In one or more embodiments, the choice of a certain channel and address is either defined by the pre-defined logic of the process or successive identification of on-line availability of addresses in the channels and the system selects the first available.

For example, usage on default of customer's contact information can be described in the process, that he/she has indicated as the main—for example, mobile phone number—and in case of his/her unavailability n times during m days (as determined by counters in the process), a sequential scan of all the other contact data including newly received and/or downloaded.

### Exemplary Use Scenario

In case the computerized system 100 is used for automating a soft debt collection process, the process flow of interaction with the debtors is specified in the computerized system depending on the sum owed, the terms of agreement giving rise to the debt and the number of the past due payments, refusals to pay and other relevant information.

In one or more embodiments, information on the debtors, including, without limitation, contact phone numbers and/or mail and/or email addresses is loaded into the computerized system 100, and the computerized system 100 used the communication framework 104 to execute a predictive parallel dialing using all available stored contact information for the debtor in accordance with the specified business process. Depending on debtors' responses to contact attempts, debtors are sent messages about the reached agreements, received or delayed payments and about legal consequences of defaults on the bills within the time allowed by the law.

Data on the payments received from the debtors influences execution of the business-process instances is regularly loaded into the computerized system 100 using manual or automatic data entry means. The computerized system 100 is further configured to generate reports with respect to the completed customer interactions, which may be organized by time, customer identity, agent identity and the like parameters, as well as with reports respect to completed and executable business-process instances.

### Exemplary Operating Sequence

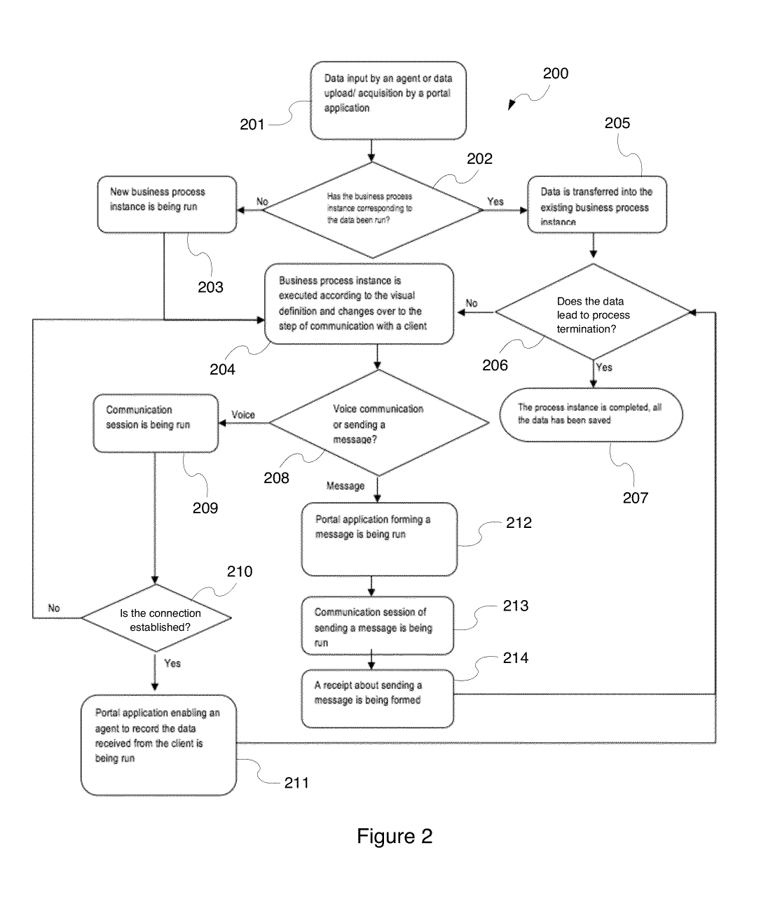

FIG. 2 illustrates an exemplary operating sequence 200 of an embodiment of the computerized system 100 for automating business processes. First, at step 201, the relevant process data is input by an agent or data upload or the data is automatically acquired by the portal application. In one or more embodiments, the input data may include the identities and contact information of business customers, such as debtors. At step 202, the computerized system 100 determines whether a process instance corresponding to the input data has already been run. If no, the new business process instance is started and begins to execute at step 203.

At step 204, the business process instance is executed according to the visual definition described above and changes over to the step of communication with the business client. If, at step 202 it is determined that the process instance corresponding to the input data has already been run, then at step 205, the input data is transferred to the existing business process instance. At step 206 it is determined whether, in view of the input data, the business process should be terminated. If so, at step 207 the business process is completed and all the associated data is saved. Otherwise, the control is passed to the aforesaid step 204.

At step 208, it is determined whether the business process being executed requires a voice communication to take place or a non-voice message to be sent. In the former case, the voice communication is initiated at step 209. At step 210 the system checks whether the voice communication connection has been successfully established. If so, at step 211, a portal application is executed enabling an agent to record the data received from the business client via the voice communication channel.

If it is determined at step 208 that a non-voice message to be sent to the business client, the portal application generating the message to be sent is being executed in step 212. At step 27, a communication session for sending the non-voice message to the business client is being established. At step 214, a conformation receipt evidencing the sending of the message is being generated and stored. Thereafter, the control is passed to the aforesaid step 206.

### Configuring Reporting Based on Formal Description of a Business Process

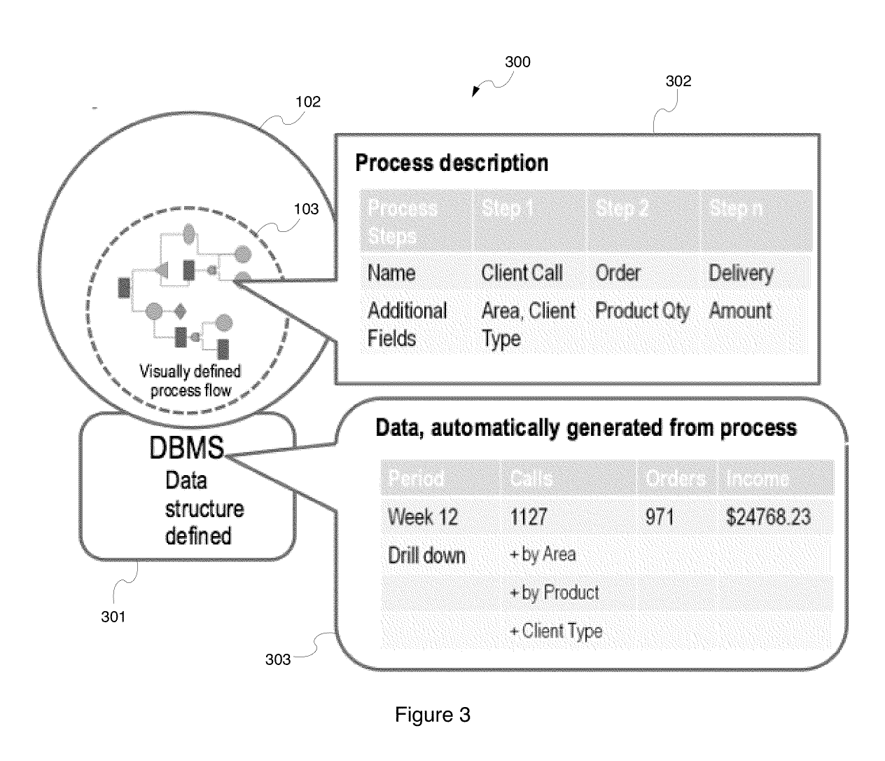

In accordance with one aspect of the embodiments described herein, there is provided a computerized system and method for automatically configuring reporting function based on the description of the business process. To this end, FIG. 3 illustrates an exemplary embodiment of one such computerized system 300. In one or more embodiments, the system 100 incorporates the business process engine 102 described in detail above as well as the database management system 301. In one or more embodiments, the database management system 301 may be implemented based on any now known or later developed type of database software, such as a relational database management system, including, without limitation, MySQL, Oracle, SQL Server, DB2, SQL Anywhere, PostgreSQL, SQLite, Firebird and/or MaxDB, which are well-known to persons of skill in the art. In an alternative embodiment, a cloud-based distributed database, such as Amazon Relational Database Service (Amazon RDS), well known to persons of ordinary skill in the art, may also be used to implement the database management system 301.

The computerized system 300 may additionally include a specially designed software application (not shown) for creating a data structure within the database management system 301 based on the aforesaid BPMN description of a business process. The inventive software application is configured to populate the created data structure with data from the instances of the business process being executed. The aforesaid automatically generated data structure populated with process data is subsequently used for generating reports on the business process.

In one or more embodiments, the business process description 302 maintained by the business process engine 102 describes a business process, such as process of servicing a business customer. The business process description 302 can be created and changed by a business user in accordance with the actual model of the business customer service using the business process editor described above. In one or more embodiments, the business process description is created in a visual form.

In one or more embodiments, the computerized system 300 automatically creates and/or modifies a data structure 303 in accordance with the aforesaid business process description 302 and the changes in the business process. In one or more embodiments, the data structure is stored in the database management system 301 in the form of database tables or records. Each business process instance executed by the business process engine 102 of the computerized system 300 corresponds to an instance of the data structure 303 stored in the database management system 301. In one or more embodiments, at any given time, the system 300 takes into account all business process data existing in the context of execution of the respective business process instance.

In one or more embodiments, in the business process description 302, not only the data directly influencing the execution of business process can be used, but also the business process data of informational and reference character. For example, additional numeric and text fields describing order pricing, amount of goods ordered, as well as geographical and other data related to customers may be described in a formalized manner in accordance with the standard BPMN business process description specification for the business process of receiving and processing of orders for delivery of goods.

In this example, the computerized system 300 will automatically create a data structure 303 including the aforesaid additional exemplary data fields (e.g. the order pricing, amount of goods ordered, as well as geographical and other data related to customers) and when making the reports it will automatically sum up or otherwise appropriately process the numerical data in the corresponding data fields in accordance with the completed business process instances.

### Exemplary Operating Sequence

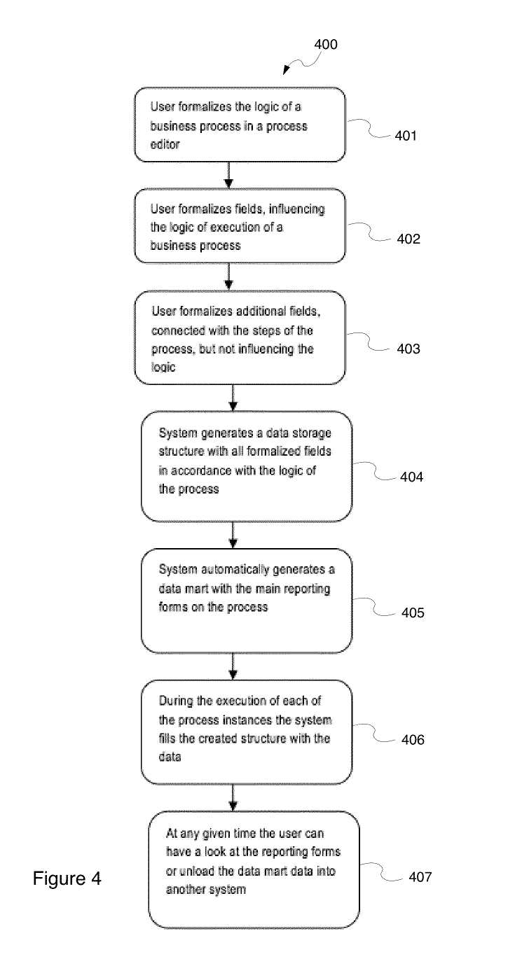

FIG. 4 illustrates an exemplary operating sequence 400 of an embodiment of the computerized system 300 for automatically configuring reporting function based on the description of the business process. First, at step 401, the user formalizes the logic of a business process in a graphical process editor, in the manner described above. After that, at step 402, user formalizes various fields, which have affect on the logic of execution of the business process. At step 403, the user formalizes additional data fields, connected with the steps of the business process, but which do not influence the business process logic (e.g. the order pricing, amount of goods ordered, as well as geographical and other data related to customers). At step 404, the computerized system 300 generates a data structure 303 with all formalized fields in accordance with the logic of the business process. At step 405, the computerized system 300 automatically generates a data-mart (data collection) with the main reporting forms associated with the business process. At step 406, which takes place during the execution of each of the business process instances, the computerized system 300 fills the created data structure with the data obtained from the respective instances of the business process. At step 407, the computerized system 300 makes the data reports related to the business process instances available to the viewing or downloading by the user.

Integration of Voice or Video Interaction Between the Operator and the Customer into the Formalized Business Process

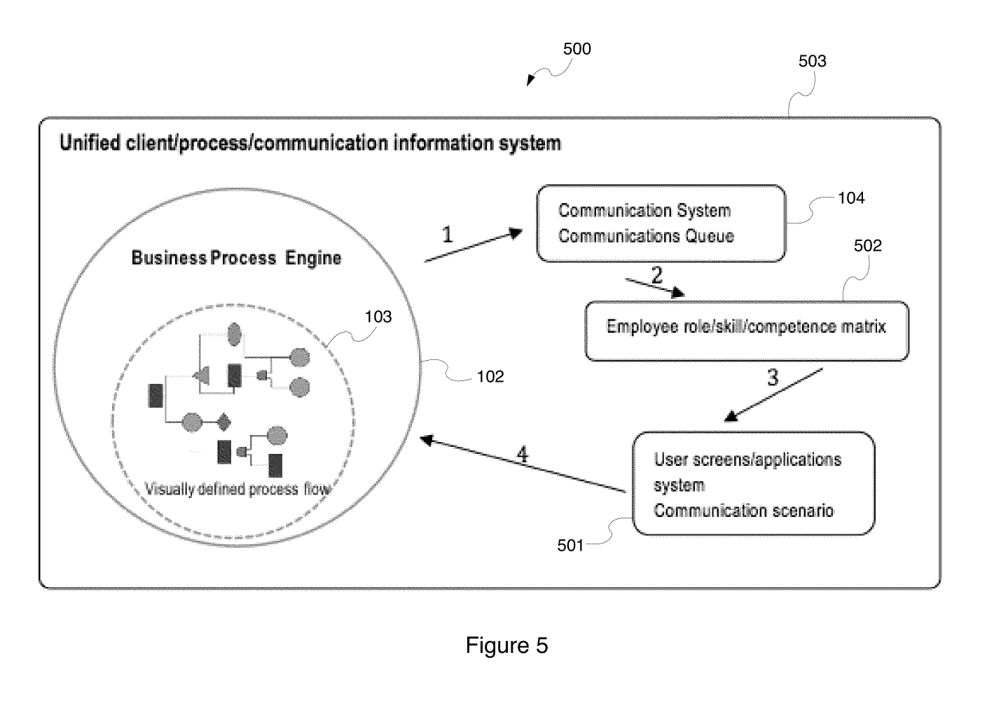

In accordance with one aspect of the embodiments described herein, there is provided a computerized system and method for Integration of voice or video interaction between the operator and the customer into the formalized business process. An exemplary embodiment 500 of one such system is illustrated in FIG. 5. The computerized system 500 incorporates a user screen application system 501, which may be deployed based on a Liferay™ system well known to persons of ordinary skill in the art or any now known or later developed equivalent thereof. Additionally, the computerized system 500 may include business process engine 102, which has been described in detail above. Additionally incorporated may be the communication system 104, which may maintain one or more communication queues. Finally, a unified client/process/communication information system 503 may be implemented as specially developed software application that is designed to enable the above system components share common data objects.

In one or more embodiments, the business process description (not shown) maintained by the business process engine 102 formally describes the business process of serving a customer. The aforesaid business process description can be created and modified by the business user in accordance with a specific real-life customer service model. In one or more embodiments, the business process description may incorporate formal specification of interaction with the customer (client).

The employee role/skill/competence matrix 502 is the formal description of the organizational structure, roles and skills/competencies of various employees of the organization, which is used by the business process logic. Specifically, the employee role/skill/competence matrix 502 may be used by the information portal, which is configured to retrieve predefined templates of conversations with the customers and automatically populate them with customer data.

In one or more embodiments, it is used communication system, all calls of which use data from the common to all systems information objects:
on the availability of the operators and operators suitability to the roles/competencies in the business process;
on the previous history of communication with the client;
on the client service process phase; and
on the client data influencing the choice of the most suitable operator (language, age, gender, difficulty in communication, etc.).

In one or more embodiments, the blocks of the form <<user task>>/<<call to the client>> are used in the formalized description of the business process. During the execution of a business process the system, performing this block alone takes on the task of client connection, after the connection the system determines the most appropriate operator of the number of available (logged into the system and declared themselves as available for the call), the connection to the client/this task in the largest complying with a set of characteristics and business process logic are distributed to the chosen operator.

In one or more embodiments, the system displays the conversation script with client data to the operator, which falls on the task execution, the system connects chosen operator to the client and system gives the opportunity to enter the data reported by the client in the fields defined in the business process; the system provides navigation on the client data in accordance with the employee access rights to the data.

In one or more embodiments, client connection is only possible as a result of the execution of a business process, which describes the logic of this interaction and the step of obtaining the address from common to all systems information object to call the client.

### Exemplary Operating Sequence

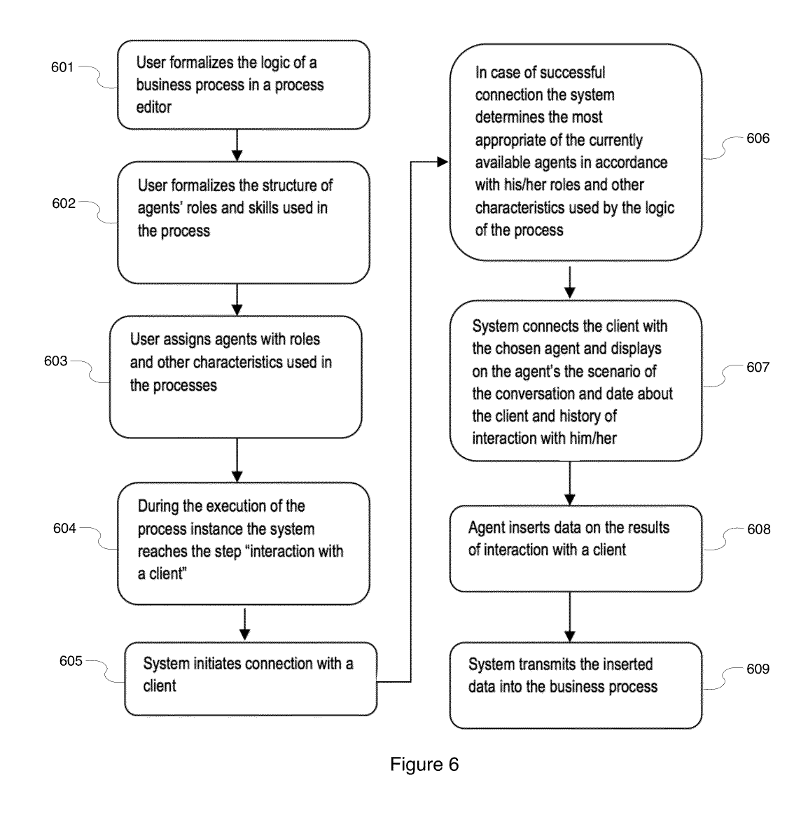

FIG. 6 illustrates an exemplary operating sequence 600 of an embodiment of the computerized system 500 for Integration of voice or video interaction between the operator and the customer into the formalized business process. First, at step 601, the user formalizes the logic of a business process in the graphical business process editor described above. At step 602, the user formalizes the structure of agents' roles and skills used within the business process. At step 603, the user assigns agents with specific roles and other characteristics used within the business processes. At step 604, which is performed during the execution of the business process instance, the computerized system 500 reaches the step involving interaction with a client. At step 605, the computerized system 500 initiated communication connection with the client. In case of a successful connection, at step 606, the computerized system 500 determines the most suitable of the currently available agents in accordance with his/her roles and other characteristics used by the logic of the business process. At step 607, the computerized system connects the client with the chosen agent and displays on the agent's screen the scenario of the conversation and automatically retrieved information about the client together with the history of interaction with the respective client. At step 608, the agent is prompted to insert data on the results of interaction with the client into an input data form. Finally, at step 609, the system transmits the inserted data into the business process, where it is appropriately handles in accordance with the business process logic. It should be noted that the aforesaid communication between the agent and the client may be performed using video and/or voice connection.

### Exemplary Embodiment of Computer Hardware Platform

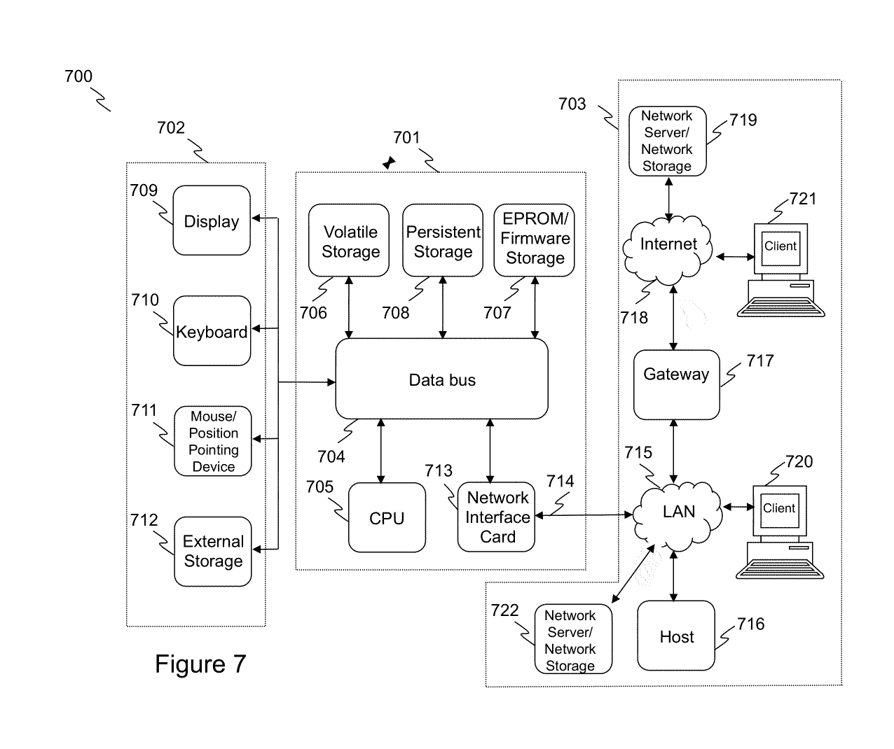

FIG. 7 illustrates an exemplary embodiment of a computer platform upon which the inventive system may be implemented. Specifically, FIG. 7 represents a block diagram that illustrates an embodiment of a computer/server system 700 upon which an embodiment of the inventive methodology may be implemented. The system 700 includes a computer/server platform 701, peripheral devices 702 and network resources 703.

In one or more embodiments, the computer platform 701 may include a data bus 704 or other communication mechanism for communicating information across and among various parts of the computer platform 701, and a processor 705 coupled with bus 704 for processing information and performing other computational and control tasks. Computer platform 701 also includes a volatile storage 706, such as a random access memory (RAM) or other dynamic storage device, coupled to bus 704 for storing various information as well as instructions to be executed by processor 705. The volatile storage 706 also may be used for storing temporary variables or other intermediate information during execution of instructions by processor 705. Computer platform 701 may further include a read only memory (ROM or EPROM) 707 or other static storage device coupled to bus 704 for storing static information and instructions for processor 705, such as basic input-output system (BIOS), as well as various system configuration parameters. A persistent storage device 708, such as a magnetic disk, optical disk, or solid-state flash memory device is provided and coupled to bus 704 for storing information and instructions.

Computer platform 701 may be coupled via bus 704 to a display 709, such as a cathode ray tube (CRT), plasma display, or a liquid crystal display (LCD), for displaying information to a system administrator or user of the computer platform 701. An input device 710, including alphanumeric and other keys, is coupled to bus 704 for communicating information and command selections to processor 705. Another type of user input device is cursor control device 711, such as a mouse, a trackball, or cursor direction keys for communicating direction information and command selections to processor 705 and for controlling cursor movement on display 709. This input device typically has two degrees of freedom in two axes, a first axis (e.g., x) and a second axis (e.g., y), that allows the device to specify positions in a plane.

An external storage device 712 may be coupled to the computer platform 701 via bus 704 to provide an extra or removable storage capacity for the computer platform 701. In an embodiment of the computer system 700, the external removable storage device 712 may be used to facilitate exchange of data with other computer systems.

The invention is related to the use of computer system 700 for implementing the techniques described herein. In an embodiment, the inventive system may reside on a machine such as computer platform 701. According to one embodiment of the invention, the techniques described herein are performed by computer system 700 in response to processor 705 executing one or more sequences of one or more instructions contained in the volatile memory 706. Such instructions may be read into volatile memory 706 from another computer-readable medium, such as persistent storage device 708. Execution of the sequences of instructions contained in the volatile memory 706 causes processor 705 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 705 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 708. Volatile media includes dynamic memory, such as volatile storage 706.

Common forms of computer-readable media include, for example, a floppy disk, a flexible disk, hard disk, magnetic tape, or any other magnetic medium, a CDROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 705 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infrared transmitter to convert the data to an infra-red signal. An infra-red detector can receive the data carried in the infra-red signal and appropriate circuitry can place the data on the data bus 704. The bus 704 carries the data to the volatile storage 706, from which processor 705 retrieves and executes the instructions. The instructions received by the volatile memory 706 may optionally be stored on persistent storage device 708 either before or after execution by processor 705. The instructions may also be downloaded into the computer platform 701 via Internet using a variety of network data communication protocols well known in the art.

The computer platform 701 also includes a communication interface, such as network interface card 713 coupled to the data bus 704. Communication interface 713 provides a two-way data communication coupling to a network link 715 that is coupled to a local network 715. For example, communication interface 713 may be an integrated services digital network (ISDN) card or a modem to provide a data communication connection to a corresponding type of telephone line. As another example, communication interface 713 may be a local area network interface card (LAN NIC) to provide a data communication connection to a compatible LAN. Wireless links, such as well-known 802.11a, 802.11b, 802.11g and Bluetooth may also be used for network implementation. In any such implementation, communication interface 713 sends and receives electrical, electromagnetic or optical signals that carry digital data streams representing various types of information.

Network link 714 typically provides data communication through one or more networks to other network resources. For example, network link 714 may provide a connection through local network 715 to a host computer 716, or a network storage/server 717. Additionally or alternatively, the network link 714 may connect through gateway/firewall 717 to the wide-area or global network 718, such as an Internet. Thus, the computer platform 701 can access network resources located anywhere on the Internet 718, such as a remote network storage/server 719. On the other hand, the computer platform 701 may also be accessed by clients located anywhere on the local area network 715 and/or the Internet 718. The network clients 720 and 721 may themselves be implemented based on the computer platform similar to the platform 701.

Local network 715 and the Internet 718 both use electrical, electromagnetic or optical signals that carry digital data streams. The signals through the various networks and the signals on network link 715 and through communication interface 713, which carry the digital data to and from computer platform 701, are exemplary forms of carrier waves transporting the information.

Computer platform 701 can send messages and receive data, including program code, through the variety of network(s) including Internet 718 and LAN 715, network link 715 and communication interface 713. In the Internet example, when the system 701 acts as a network server, it might transmit a requested code or data for an application program running on client(s) 720 and/or 721 through Internet 718, gateway/firewall 717, local area network 715 and communication interface 713. Similarly, it may receive code from other network resources.

The received code may be executed by processor 705 as it is received, and/or stored in persistent or volatile storage devices 708 and 706, respectively, or other non-volatile storage for later execution.

It should be understood that processes and techniques described herein are not inherently related to any particular apparatus and may be implemented by any suitable combination of software components. Further, various types of general purpose software components may be used in accordance with the teachings described herein. It may also prove advantageous to extend the taxonomy as well as number of media Channels and Channel Actions to perform the method steps described herein. The present invention has been described in relation to particular examples, which are intended in all respects to be illustrative rather than restrict. Those skilled in the art will appreciate that many different combinations of software components, and software services will be suitable for practicing the present invention. For example, the described software may be implemented in a wide variety of programming or scripting languages, such as .NET, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized systems and computer-implemented methods for automation of business processes. It is intended that the specification and examples be considered as exemplary only, with a true scope and spirit of the invention being indicated by the following claims.

1. A computerized system for automating a business process, the computerized system comprising at least one processing unit, a data storage unit and a memory unit, the at least one processing unit executing a set of computer-readable instructions implementing a method comprising:
a. receiving data associated with the business process from an agent or by means of a data upload and storing the received data in the data storage unit;
b. determining whether a business process instance corresponding to the received data has already been run, and, if not, initiating the business process instance and passing the received data to the initiated business process instance;
c. executing the business process instance according to a visual definition of the business process specified by the user;
d. determining whether the business process requires a voice communication with a customer and, if so, initiating a voice communication connection between an agent and the customer; and
e. determining whether the business process requires a message to be sent to the customer and, if so, automatically generating the message and sending the generated message to the customer.

2. A computer-implemented method for automating a business process, the computer-implemented method being performed in connection with a computerized system comprising at least one processing unit, a data storage unit and a memory unit, the computer-implemented method comprising:
a. receiving data associated with the business process from an agent or by means of a data upload and storing the received data in the data storage unit;
b. determining whether a business process instance corresponding to the received data has already been run, and, if not, initiating the business process instance and passing the received data to the initiated business process instance;
c. executing the business process instance according to a visual definition of the business process specified by the user;
d. determining whether the business process requires a voice communication with a customer and, if so, initiating a voice communication connection between an agent and the customer; and
e. determining whether the business process requires a message to be sent to the customer and, if so, automatically generating the message and sending the generated message to the customer.

3. A non-transitory computer-readable medium embodying a set of instructions, which, when executed in connection with a computerized system comprising at least one processing unit, a data storage unit and a memory unit, cause the computerized system to perform a computer-implemented method comprising:
a. receiving data associated with the business process from an agent or by means of a data upload and storing the received data in the data storage unit;
b. determining whether a business process instance corresponding to the received data has already been run, and, if not, initiating the business process instance and passing the received data to the initiated business process instance;
c. executing the business process instance according to a visual definition of the business process specified by the user;
d. determining whether the business process requires a voice communication with a customer and, if so, initiating a voice communication connection between an agent and the customer; and
e. determining whether the business process requires a message to be sent to the customer and, if so, automatically generating the message and sending the generated message to the customer.

4. The computerized system of claim 1, wherein the method further comprises generating a graphical user interface configured to receive the visual definition of the business process from the user.

5. The computerized system of claim 1, wherein the visual definition of the business process is provided in a form of a business process model and notation (BPMN) diagram.

6. The computerized system of claim 1, wherein the voice communication connection between an agent and the customer is initiated using a voice-over IP communication protocol.

7. The computerized system of claim 1, wherein the method further comprises generating a voice communication information user interface for receiving information associated with the voice communication from the agent.

8. The computerized system of claim 1, wherein the method further comprises storing in the data storage unit records associated with the voice communication and the message sent to the customer.

9. The computer-implemented method of claim 2, further comprising generating a graphical user interface configured to receive the visual definition of the business process from the user.

10. The computer-implemented method of claim 2, wherein the visual definition of the business process is provided in a form of a business process model and notation (BPMN) diagram.

11. The computer-implemented method of claim 2, wherein the voice communication connection between an agent and the customer is initiated using a voice-over IP communication protocol.

12. The computer-implemented method of claim 2, further comprising generating a voice communication information user interface for receiving information associated with the voice communication from the agent.

13. The computer-implemented method of claim 2, further comprising storing in the data storage unit records associated with the voice communication and the message sent to the customer.

14. The non-transitory computer-readable medium of claim 3, wherein the method further comprises generating a graphical user interface configured to receive the visual definition of the business process from the user.

15. The non-transitory computer-readable medium of claim 3, wherein the visual definition of the business process is provided in a form of a business process model and notation (BPMN) diagram.

16. The non-transitory computer-readable medium of claim 3, wherein the voice communication connection between an agent and the customer is initiated using a voice-over IP communication protocol.

17. The non-transitory computer-readable medium of claim 3, wherein the method further comprises generating a voice communication information user interface for receiving information associated with the voice communication from the agent.

18. The non-transitory computer-readable medium of claim 3, wherein the method further comprises storing in the data storage unit records associated with the voice communication and the message sent to the customer.
